(19) United States
(12) Patent Application Publication
(10) Pub. No.: US 2005/0050091 A1
(43) Pub. Date: Mar. 3, 2005

(54) Inspection reservation system

(75) Inventor: Masayuki Inoue, Tokyo (JP)

Correspondence Address: CARRIER BLACKMAN AND ASSOCIATES, 24101 NOVI ROAD, SUITE 100, NOVI, MI, 48375, US

(73) Assignee: Honda Giken Kogoyo Kabushiki Kaisha

(21) Appl. No.: 10/479,452

(22) PCT Filed: May 29, 2002
(86) PCT No.: PCT/JP02/05173

(30) Foreign Application Priority Data
Jun. 13, 2001 (JP) 2001-179258

(51) Int. Cl. G06F 7/00

(52) U.S. Cl. 707/104.1

(57) ABSTRACT

An inspection reservation system used for reservation of inspection maintenance of a vehicle includes a first database for storing step count information indicating the number of steps required for inspection and maintenance of a vehicle, a second database for storing skill information containing a plurality of skill values indicating skills of maintenance staffs, and a processing apparatus. The processing apparatus calculates a total number of steps required for inspection and maintenance of a vehicle related to a reservation imputed to the system in accordance with the step count information. Furthermore, in accordance with the total number of steps and the skill information, the processing apparatus selects at least one maintenance staff who can perform the inspection and maintenance of the vehicle related to the reservation within a desired period of time.

### TECHNICAL FIELD

The present invention relates to a check reserving system for a vehicle, in particular, the present invention relates to a check reserving system used to reserve a check and a maintenance (hereafter, a check and a maintenance may be merely referred to as a check) in which items to be carried out are defined such as a regular repairing.

### BACKGROUND ART

Vehicle maintenance workshops provide vehicle check services of checking vehicles in response to requests from clients. When receiving a request of a check from a client, a manager of a maintenance shop for providing vehicle check services is required to determine a date for the check of the vehicle considering the maintenance schedule of the maintenance shop. Typically, the manager of the maintenance workshop determines the date for the check of the vehicle as follows. At first, the manager adds up respective man-hours of a plurality of check items which are defined for each kind of the check, and calculates the total man-hour. Then, the manager looks for the dates when the check requested by the client can be executed from the calculated total man-hour and the maintenance schedule of the maintenance workshop, and selects the optimal date from the dates. The check of the vehicle is executed on the selected date.

A storage management system for automatically preparing a schedule of a maintenance workshop in response to a request of a check from a client is disclosed in Japanese Laid Open Patent Application (Jp-A 2000-20581). The storage management system includes a terminal for operation by the client and a host computer. When the client enters a content of the maintenance and a desired storage condition from the terminal, the host computer calculates a period necessary for the maintenance on the basis of the maintenance content, and further detects a maintainable empty time based on the desired condition by the client, on the basis of a storage/delivery management table stored in a memory of the host computer. The optimal storage date in the period is automatically determined and displayed on the terminal. In accordance with the input of the determination of the client from the terminal, the optimal storage date and a delivery date determined from the storage date is automatically registered in the storage/delivery table to achieve a storage reservation. Consequently, the registration of the storage can be achieved by the client by himself.

Because of the background of social situation in recent years, the temporal request from the client with regard to the check of the vehicle has been further severe. For example, more and more clients request the check to be completed in a short time, such as half an hour and 1 hour during commuting. For this reason, the realization of the check reserving system is desired which can satisfy the temporal request of the client as much as possible.

### DISCLOSURE OF INVENTION

The object of the present invention is to provide a check reserving system that can satisfy a temporal request of a client to provide an excellent client service.

In order to achieve the object, a check reserving system according to the present invention includes a first database for storing man-hour information representative of man-hours required for checking and maintaining vehicles, a second database for storing skill information including a plurality of skill values respectively representative of skills of a plurality of mechanics, and a processor. The processor calculates a total man-hour required for a check and maintenance of a vehicle with respect to a reservation on the basis of the man-hour information. Moreover, the processor selects at least one mechanic who can execute said check and said maintenance of the vehicle with regard to said reservation so as to satisfy a desired date of the delivery on the basis of the total man-hour and the skill information

Here, the man-hour implies the amount of the work required for executing the check and maintenance, and it is represented by a time required for one mechanic to complete the check and the maintenance. The skill implies the number of the experienced years of a mechanic, the content of a previously experienced work (repair), the content of a previously received training and the like, and the skill value represent the skill by converting the skill into a numeral in accordance with a predetermined rule.

The check reserving system enables to execute the check requested by the client taking count of the skills of the mechanics. The check reserving system assigns the mechanic having the high skill for the content of the check of the vehicle with regard to the reservation, to the request of the check whose desired delivery date is close. Moreover, if the process of the check can not be completed even by assigning the mechanic having the high skill, the check reserving system further assigns another mechanic in addition to the mechanic. Since the other mechanic is added and assigned, the work is carried out by a plurality of mechanics, and thus the process of the check can be completed until the desired delivery date, or it can be completed at the date as close as possible to the desired delivery date. In this way, the check reserving system enables to satisfy the temporal request of the client as much as possible.

The first database may further store as a necessary skill value a skill value required to execute the check item with respect to each of check items included in the check and the maintenance of the vehicle. In this case, it is preferable that the processor selects said at least one mechanic from among mechanics having a skill value equal to or higher than the necessary skill value defined for the check items included in the check and the maintenance of the vehicle with respect to the reservation.

The first database may further store place information representative of a work place required for checking and maintaining the vehicle. In this case, it is preferable that the processor further retrieves to reserve the work place required for the check and the maintain the vehicle with respect to the reservation so as to satisfy the desired delivery date of the vehicle with regard to the reservation, on the basis of the place information stored in the first database.

The first database may further store expense information representative of a check and maintenance expense of the vehicle. In this case, it is preferable that the processor further calculates and outputs the expense required for the check and maintenance of the vehicle with respect to the reservation, on the basis of the expense information stored in the first database.

### BRIEF DESCRIPTION OF DRAWINGS

FIG. 1 is a block diagram showing a configuration of a check reserving system in an embodiment according to the present invention.

FIG. 2 is a flowchart describing an operation of the check reserving system in the embodiment according to the present invention.

### BEST MODE FOR CARRYING OUT THE INVENTION

A check reserving system in an embodiment according to the present invention will be described below in detail with reference to the attached drawings.

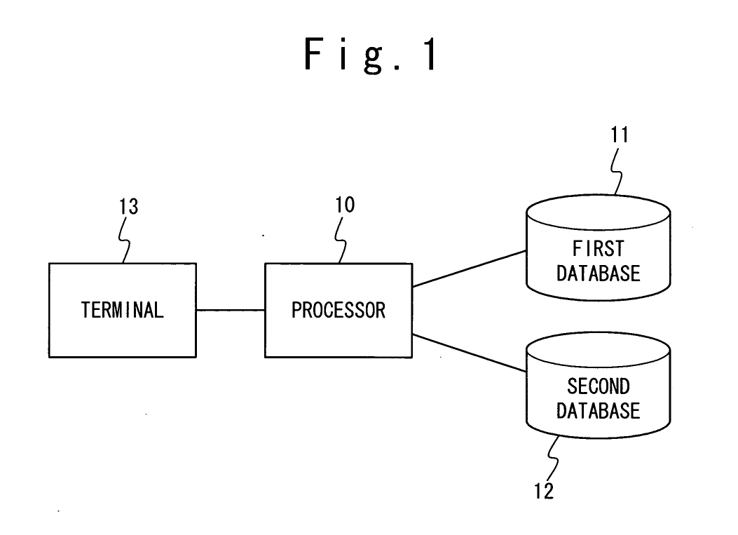

FIG. 1 is a block diagram showing the schematic configuration of the check reserving system in one embodiment according to the present invention. The check reserving system includes a processor 10, a first database 11, a second database 12 and a terminal 13.

The processor 10 is connected to the first database 11 and the second database 12. The processor 10 executes various processes in response to commands from the terminal 13 on the basis of the contents of the first database 11 and the second database 12. An information processor such as a personal computer, a workstation or a general computer is used as the processor 10.

The first database 11 stores a necessary man-hour, an expense, a necessary skill value and a work place for each check item of vehicles. The first database 11 is provided with about 40,000 to 60,000 check items. The preparation of such the many check items enables the content of the check to be determined in detail, and thereby enables the time and the expense necessary for the check to be precisely calculated.

The second database 12 stores skill information including a plurality of skill values respectively representative of skills of a plurality of mechanics. In detail, the second database 12 stores the skill values in which the skills of the plurality of mechanics, namely, the number of the experienced years, the contents of previously experienced works (repair), the contents of previously received training and the like, are converted into numerals, in accordance with a predetermined rule.

“Man-hours”, which are included in the first database 11, indicate the amount of the work required to execute a job needed to execute each check item, and it is represented by a time required for a single mechanic to complete each check item. The unit of “man-hour” is [Human-Hour]. An “expense” implies the expense required for executing each check item. Also, a “necessary skill value” represents the skill value required for a mechanic to execute the check items. Moreover, a “work place” is the place required to execute the checks. The allowance and prohibition of the usage of a “work place” is sequentially updated in association with the progress of the maintenance schedule.

The terminal 13 is used for inputting reservation information to inquire about the allowance or rejection of a reservation when a request of a check is received from a client, and is used for displaying the judged result with respect to the allowance or rejection of the reservation. The terminal 13 is typically provided with a keyboard and a monitor device.

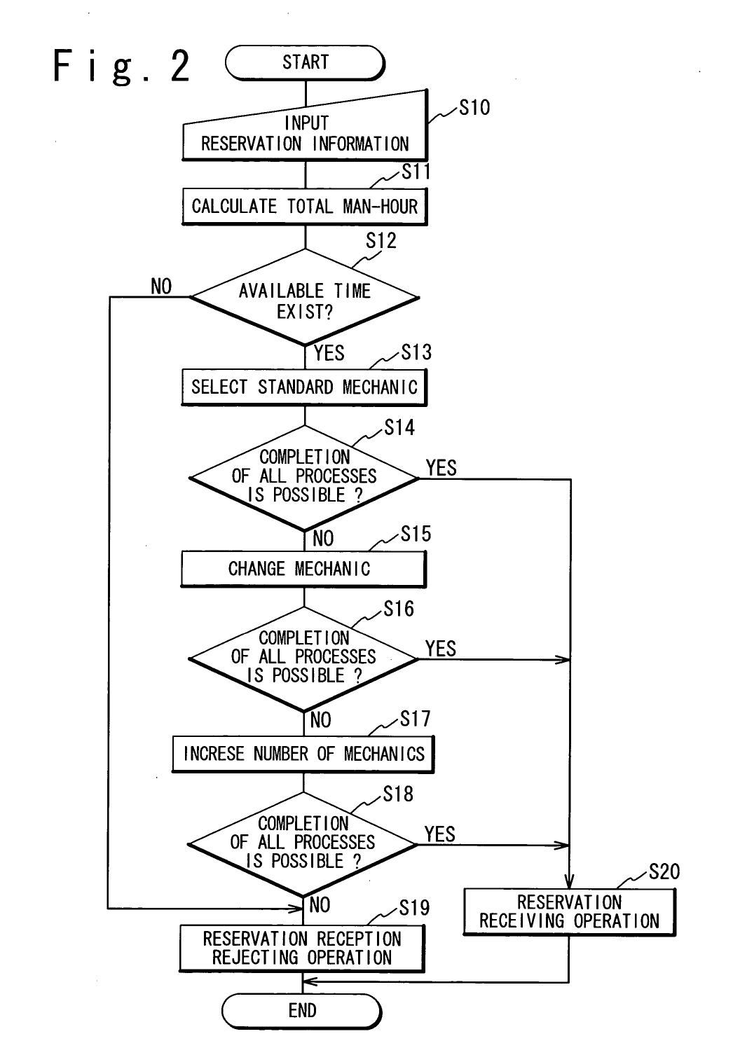

FIG. 2 is a flowchart showing a reserving process for reserving a check by using a check reserving system having the above-mentioned configuration.

The reserving process starts with an input of a reservation information (Step S10). When a reservation request of a check is received from a client, reservation information is inputted from the terminal 13. The inputted reservation information includes a content of a check of a vehicle, such as a legal vehicle inspection, a legal six-month check, and a check of a particular portion, and a desired date of service, such as a date when the vehicle is entered into the workshop and a date when the vehicle is delivered.

When the reservation information is inputted from the terminal 13, the processor 10 calculates the total man-hour of the checks (Step S11). In order to calculate the total man-hour of the checks, the processor 10 firstly extracts the check items to be executed on the basis of the content of the check, which is included in the reservation information. Next, the processor 10 adds the man-hours stored in the first database 11 for each of the extracted check item, and calculates the sum of the man-hours as the total man-hour.

After the calculation of the total man-hour, it is judged whether or not there is available time in the maintenance schedule (Step S12). In this operation, it is judged whether or not there are mechanics who are not assigned to other maintenance works in a time band of the desired delivery date and has the necessary skill value necessary for the respective check items included in the check with respect to the reservation. In the case of the existence, it is judged whether or not the work place used for the checking work can be reserved, by referring to the place information stored in the first database 11. If the two conditions are satisfied, it is judged that there is available time. Here, when it is judged that there is no available time, the reserving process jumps to a step S19 to execute a reservation reception rejecting operation.

On the other hand, if it is judged at the step S12 that there is available time, a standard mechanic is selected (Step S13). That is, a mechanic is selected who is not assigned to the other maintenance works in the time band of the desired delivery date and has the necessary skill value necessary for the respective check items included in the check with regard to the reservation. The standard mechanic implies the worker who can execute the checking work at a standard man-hour, in short, the worker having the average skill.

Next, whether or not all of the processes of the check can be carried out by the selected standard mechanic is judged on the basis of the total man-hour calculated at the step S11 (Step S14). Here, when it is judged that they can be executed, the reserving process jumps to a step S20 to execute a reservation receiving operation.

In the reservation receiving operation, the expense required to check the vehicle is calculated, and the expense is presented to the client. The calculation of the expense is executed by totaling the costs stored in the first database 11 for each check item. If the client accepts the presented expense, the reservation receiving operation is ended.

When it is judged that the operations of all the processes in the check can not be attained at the step S14, the mechanic is changed (Step S15). That is, a mechanic, who is not assigned to the other maintenance works and has the necessary skill value necessary for the respective check items included in the check with respect to the reservation and also has a skill value higher than the standard mechanic, is selected by querying the second database 12. Then, it is judged whether or not all the processes of the check can be executed (Step S16). Here, if it is judged that they can be done, the sequence branches into the step S20, and the reservation receiving operation is carried out.

Also, the step S14 may be designed such that a mechanic having a skill value lower than the standard mechanic is retrieved from the second database 12 when the selected standard mechanic can execute all the processes in the check, and whether or not all the processes in the check can be carried out is judged, and the less-skilled mechanic is selected when all the processes can be completed. In the same way, whether or not the total man-hour can be executed is sequentially judged by querying a mechanic having a much lower skill value from the second database 12, and the much-less-skilled mechanic may selected when all the processes can be completed. This configuration enables to assign to the maintenance work the mechanics having the various skills as well as the mechanic having the high skill value.

When it is judged at the step S16 that all the processes in the check can not be completed, the reserving process is returned back to the step S15. In this case, the reserving process may be designed such that a mechanic, who is not assigned to other maintenance works and has the necessary skill value necessary for the respective check items included in the check with respect to the reservation and has a skill value much higher than the previously selected mechanic, is selected by querying the second database 12, and whether or not the selected mechanic can execute all the processes in the check is judged, and the mechanic is selected when the more-skilled mechanic can complete all the processes. In the same way, the reserving process may be designed such that whether or not all the processes in the check can be completed is sequentially judged by querying a mechanic having a much higher skill value from the second database 12, and the much-more-skilled mechanic is selected if all the process can be completed.

When it is judged at the Step S16 that a mechanic who is not assigned to other maintenance works can not complete the operations of all the processes in the check, the addition of the mechanic is executed (Step S17). That is, two mechanics, who are not assigned to other maintenance works and have the necessary skill value necessary for the respective check items included in the check with respect to the reservation, are selected by querying the second database 12. Then, whether or not all the processes in the check can be completed is judged on the basis of the total man-hour calculated at the step S11 (Step S18). Any algorithm can be used as an algorithm to select the two mechanics. When it is judged that all the processes in the check can be completed, the sequence of the reserving process jumps to the step S20 to execute the reservation receiving operation.

It should be noted that although the illustration is omitted in FIG. 2, the reserving process may be designed such that if the completion of all the processes in the check is judged to be impossible at the step S18, the reservation process is returned back to the step S17, and three mechanics, who are not assigned to other maintenance works and have the necessary skill value necessary for the respective check items included in the check with respect to the reservation, is selected by querying the second database 12, and whether or not the total man-hour can be coped with, and the three mechanics are selected when the total man-hour can be coped with. In the same way, similarly, the reserving process may be designed such that whether or not all the processes in the check can be carried out is sequentially judged with the number of the mechanics further increased, and the plurality of mechanics are selected if all the processes can be completed.

However, the number of the mechanics is limited on the basis of the spatial restrictions of the check place and the work place in which the maintenance work is executed. For example, when the area of the work place is not sufficient, the work speed of the check work is not increased even if the number of the mechanics is increased. Moreover, for example, when the case that the check portion is an engine room is considered, the number of the mechanics who can be engaged in the check of the engine room is limited. Thus, the work speed of the check work is not increased even if the number of the mechanics is increased. Hence, the number of the mechanics is increased considering the spatial restrictions of the check place and the work place in which the maintenance work is executed.

If the execution of the operation of all the processes in the check is judged to be impossible at the step S18, a reservation reception rejecting operation is executed (Step S19). The reservation reception rejecting operation inquires about the acceptation or rejection of the change in the desired delivery date of the client (Step S19). If the change is accepted, the operations at the above-mentioned steps S10 to S20 are repeated for the changed desired delivery date.

When the present check reserving systems are introduced in a plurality of maintenance workshops and the check reserving systems are connected through a network, the reservation reception rejecting operation may request another maintenance workshop to execute the check. In this case, the reservation information is transferred to the check reserving system of another maintenance workshop from the check reserving system of the maintenance workshop that has received the request of the check. The check reserving system of another maintenance workshop executes the operations at the above mentioned steps S10 to S20.

As explained above, the check reserving system in this embodiment can execute the check requested by the client considering the skill of the mechanics. The mechanic having the high skill for the content of the maintenance and check of the vehicle with respect to the reservation is assigned to the request of the check whose desired delivery date is close. Nevertheless, if all the processes in the check can not be completed, in addition to the mechanic, another mechanic is assigned, and the work is executed by the plurality of mechanics. Consequently, the check can be attained in the delivery date corresponding to the request from the client. In this way, the check reserving system in this embodiment can satisfy the temporal request from the client as much as possible and thereby provide the excellent client service.

1. A check reserving system comprising:
a first database for storing man-hour information representative of man-hours required for checking and maintaining vehicles;
a second database for storing a skill information including a plurality of skill values respectively representative of skills of a plurality of mechanics; and
a processor for calculating a total man-hour required for a check and a maintenance of a vehicle with respect to a reservation on the basis of said man-hour information, and selecting at least one mechanic who can carry out said check and said maintenance of said vehicle with regard to said reservation so as to satisfy a desired delivery date on the basis of said total man-hour and said skill information.

2. A check reserving system according to claim 1, wherein said first database further stores as a necessary skill value a skill value required to carry out said check item for each of check items included in said check and said maintenance of the vehicle, and
said processor selects said at least one mechanic, from mechanics having a skill value equal to or higher than said necessary skill value defined for said check items included in said check and said maintenance of said vehicle with respect to said reservation.

3. A check reserving system according to claim 1, wherein said first database further stores place information representative of work places required for checking and maintaining vehicles, and
said processor retrieves to reserve a work place required for said check and said maintenance of said vehicle with respect to said reservation so as to satisfy said desired delivery date of said vehicle with respect to said reservation, on the basis of said place information stored in said first database.

4. A check reserving system according to claim 1, wherein said first database further stores expense information representative of a check and maintenance expense of vehicles, and
said processor further calculates and outputs an expense required for said check and said maintenance of said vehicle with respect to said reservation, on the basis of said expense information stored in said first database.

5. A check reserving system according to claim 1, wherein said first database further stores as a necessary skill value a skill value required to carry out said check for each of check items included in said check and said maintenance of the vehicle,
wherein said processor selects said at least one mechanic, from mechanics having a skill value equal to or higher than said necessary skill value defined for said check items included in said check and said maintenance of said vehicle with respect to said reservation,
wherein said first database further stores place information representative of work places required for checking and maintaining vehicles, and
wherein said processor retrieves to reserve a work place required for said check and said maintenance of said vehicle with respect to said reservation so as to satisfy said desired delivery date of said vehicle with respect to said reservation, on the basis of said place information stored in said first database.

6. A check reserving system according to claim 5, wherein said first database further stores expense information representative of a check and maintenance expense of vehicles, and
wherein said processor further calculates and outputs an expense required for said check and said maintenance of said vehicle with respect to said reservation, on the basis of said expense information stored in said first database.

7. A check reserving system according to claim 1, wherein said first database further stores as a necessary skill value a skill value required to carry out said check for each of check items included in said check and said maintenance of the vehicle,
wherein said processor selects said at least one mechanic, from mechanics having a skill value equal to or higher than said necessary skill value defined for said check items included in said check and said maintenance of said vehicle with respect to said reservation,
wherein said first database further stores expense information representative of a check and maintenance expense of vehicles, and
wherein said processor further calculates and outputs an expense required for said check and said maintenance of said vehicle with respect to said reservation, on the basis of said expense information stored in said first database.

8. A check reserving system according to claim 1, wherein said first database further stores place information representative of work places required for checking and maintaining vehicles,
wherein said processor retrieves to reserve a work place required for said check and said maintenance of said vehicle with respect to said reservation so as to satisfy said desired delivery date of said vehicle with respect to said reservation, on the basis of said place information stored in said first database,
wherein said first database further stores expense information representative of a check and maintenance expense of vehicles, and
wherein said processor further calculates and outputs an expense required for said check and said maintenance of said vehicle with respect to said reservation, on the basis of said expense information stored in said first database.

9. A check reserving system according to claim 1, further including a terminal through which the reservation may be inputted to the system.
